(19) United States
(12) Patent Application Publication
(10) Pub. No.: US 2008/0212543 A1
(43) Pub. Date: Sep. 4, 2008

(54) RADIO COMMUNICATION SYSTEM, BASE STATION AND RADIO COMMUNICATION METHOD

(75) Inventor: Koichiro Ban, Kawasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/968,437

(22) Filed: Jan. 2, 2008

(30) Foreign Application Priority Data
Jan. 10, 2007 (JP) 2007-002735

(51) Int. Cl. H04J 3/06

(52) U.S. Cl. 370/336

(57) ABSTRACT

The present invention is provided with a control channel searching unit 90 which measures reception power levels of a plurality of control channels, searches for a control channel having a small reception power level and thereby determines the control channel to be used, a format specification unit 140 which specifies a desired channel format from among a plurality of channel formats according to a determined control channel to be used and base station communication units 170,110, 120, 50, 40, 20 which communicate with a mobile station using the desired channel format.

### CROSS REFERENCE TO RELATED APPLICATIONS

This application is based upon and claims the benefit of priority from the prior Japanese Patent Applications No. 2007-002735, filed on Jan. 10, 2007; the entire contents of which are incorporated herein by reference.

### BACKGROUND OF THE INVENTION

1. Field of the Invention

The present invention relates to a distributed autonomous radio communication system, and more particularly, to a method of determining a channel format.

2. Related Art

A next-generation PHS system currently under study is supposed to become a distributed autonomous radio communication system which will avoid an arrangement of base stations through deliberate calculations or the like. In a distributed autonomous radio communication system which uses communication resources by sharing them with neighboring base stations, there seems to be no problem even if the same format is used for all communication resources (slots) from the standpoint of its original concept. Actually, all communication slots in current PHS have basically the same format.

That is, in a conventional distributed autonomous radio communication system such as PHS, all base stations use a common format (e.g., see “Second-Generation Cordless Telephone System Standard RCR STD-28, Association of Radio Industries and Businesses”).

However, in order to realize higher frequency utilization efficiency also in the distributed autonomous radio communication system, there is a tendency to reuse common communication resources also at neighboring base stations using beam forming, MIMO technology or the like. In such a situation, it is no longer possible to ignore interference from the neighboring base stations and when all base stations use the same format, the problem with interference becomes more conspicuous.

In such a conventional distributed autonomous radio communication system, since all base stations use the same format, there is a problem that influences of interference from other cells are considerable.

### SUMMARY OF THE INVENTION

According to an aspect of the present invention, there is provided with a radio communication system using frames each including a plurality of control channels and a plurality of communication channels as transmission units, comprising at least a base station and a mobile station communicating therebetween by radio,

the base station comprising:

a synchronization establishing unit configured to detect start timing of a super frame formed of a plurality of frames and establish synchronization of the super frame with other base stations;

a control channel searching unit configured to measure reception power levels of the control channels, search for the control channel having a small reception power level and thereby determine the control channel to be used;

a format specification unit configured to specify a desired channel format from among a plurality of channel formats according to a determined control channel to be used; and

a base station communication unit configured to communicate with the mobile station using the desired channel format, and

the mobile station comprising:

a control channel detecting unit configured to detect signals of the control channel transmitted from the base station; and

a mobile station communication unit configured to communicate with the base station using the channel format specified at the base station.

According to an aspect of the present invention, there is provided with a base station using frames each including a plurality of control channels and a plurality of communication channels as transmission units, communicating with a mobile station by radio, comprising:

a synchronization establishing unit configured to detect start timing of a super frame formed of a plurality of frames and establish synchronization of the super frame with other base stations;

a control channel searching unit configured to measure reception power levels of the control channels, search for the control channel having the small reception power level and thereby determine the control channel to be used;

a format specification unit configured to specify a desired channel format from among a plurality of channel formats according to a determined control channel to be used; and

a base station communication unit configured to communicate with the mobile station using the desired channel format.

According to an aspect of the present invention, there is provided with a radio communication method for a radio communication system using frames each including a plurality of control channels and a plurality of communication channels as transmission units, comprising at least a base station and a mobile station communicating therebetween by radio, comprising:

detecting by the base station start timing of a super frame formed of a plurality of frames and establishes synchronization of the super frame with other base stations,

measuring by the base station reception power levels of the control channels, searching for the control channel having the small reception power level and thereby determining the control channel to be used,

specifying by the base station a desired channel format from among a plurality of channel formats according to a determined control channel to be used, and

communicating with the mobile station using the desired channel format, and

detecting by the mobile station signals of the control channel transmitted from the base station, and

communicating with the base station using the channel format specified at the base station.

### BRIEF DESCRIPTION OF THE DRAWINGS

FIG. 1 is a configuration example of a distributed autonomous radio communication system according to an embodiment of the present invention;

FIG. 2 shows the frame configuration by TDD of the distributed autonomous radio communication system according to the embodiment of the present invention;

FIG. 3 shows the frame configuration by FDD of the distributed autonomous radio communication system according to the embodiment of the present invention;

FIG. 4 shows the channel (slot) configuration according to the embodiment of the present invention;

FIG. 5 illustrates the method of determining a control channel at the base station according to the embodiment of the present invention;

FIG. 6 shows a configuration example of the base station according to the embodiment of the present invention;

FIG. 7 shows a configuration example of the mobile station according to the embodiment of the present invention;

FIG. 8 is a first configuration example of the timing detecting unit of the base station according to the embodiment of the present invention;

FIG. 9 is a second configuration example of the timing detecting unit of the base station according to the embodiment of the present invention;

FIG. 10 illustrates the method of determining the timing of a super frame by the second configuration example of the timing detecting unit of the base station according to the embodiment of the present invention;

FIG. 11 shows a first configuration example of the channel format according to the embodiment of the present invention;

FIG. 12 shows a second configuration example of the channel format according to the embodiment of the present invention;

FIG. 13 shows a third configuration example of the channel format according to the embodiment of the present invention;

FIG. 14 shows a configuration example of CCH1 in the third configuration example of the channel format according to the embodiment of the present invention;

FIG. 15 shows a configuration example of the downlink channel in the third configuration example of the channel format according to the embodiment of the present invention;

FIG. 16 shows a configuration example of the uplink channel in the third configuration example of the channel format according to the embodiment of the present invention; and

FIG. 17 shows a fourth configuration example of the channel format according to the embodiment of the present invention.

### DETAILED DESCRIPTION OF THE INVENTION

Hereinafter, an embodiment of the present invention will be explained in detail with reference to drawings.

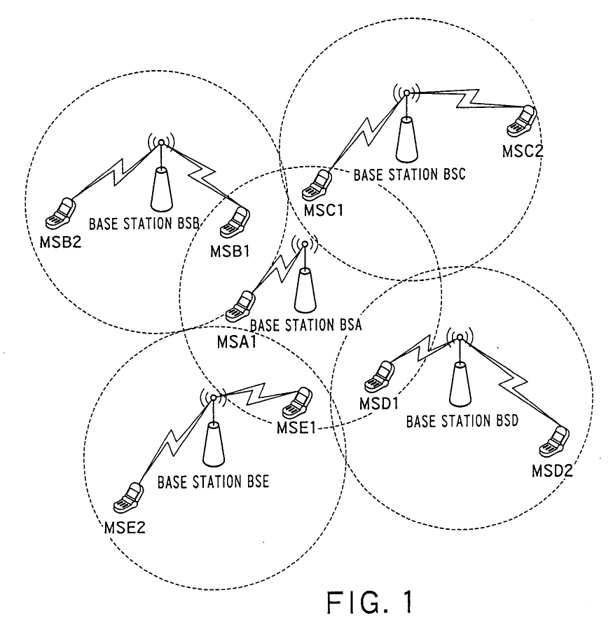

FIG. 1 shows a configuration example of a distributed autonomous radio communication system 10 according to this embodiment and this distributed autonomous radio communication system 10 is composed of a plurality of base stations BSA to BSE and mobile stations MS.

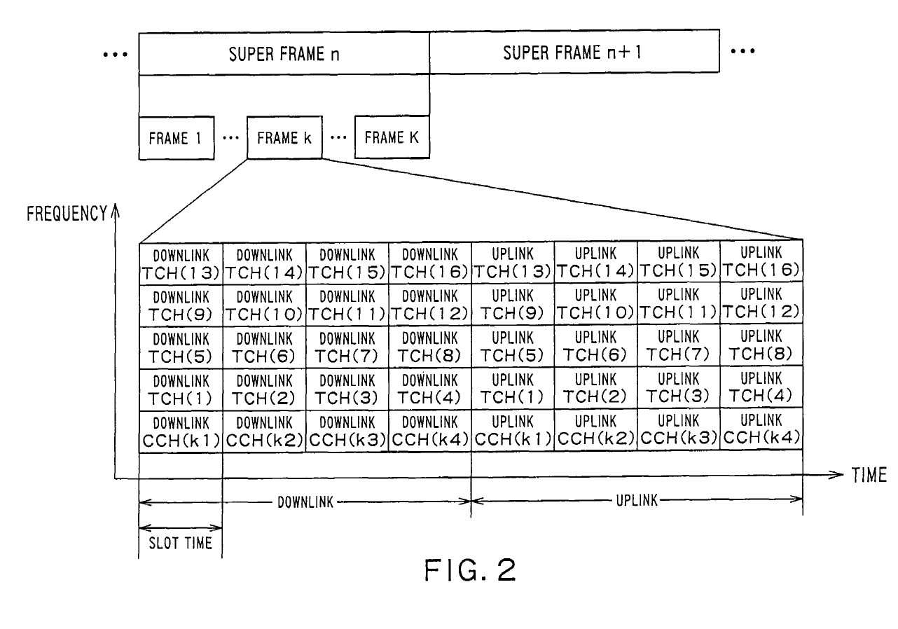

FIG. 2 shows a frame configuration example of the distributed autonomous radio communication system 10 according to this embodiment. One frame is constructed of a plurality of control channels CCH and communication channels TCH and downlink channels (downlink control channel, downlink communication channel) and uplink channels (uplink control channel, uplink communication channel) are temporally divided according to a time division duplex scheme (TDD scheme). A control channel CCH and a communication channel TCH are paired between the downlink and the uplink, and when a base station BS uses a control channel CCH or a communication channel TCH, it uses them by securing a pair thereof on the downlink and the uplink.

For example, downlink control channel CCH(k1) and uplink control channel CCH(k1) are paired and downlink communication channel TCH(1) and uplink communication channel TCH(1) are paired. In the example of this figure, 4 channels of control channel CCH and 16 channels of communication channels TCH exist in one frame.

Furthermore, a plurality of frames constitute a super frame as shown in FIG. 2. The number of communication channels TCH of the distributed autonomous radio communication system 10 is defined by a frame period and the number of control channels CCH is defined by the super frame period. As shown in FIG. 2, when one frame is made up of 8 slots (4 downlink slots, 4 uplink slots) and K frames (K is an integer equal to or greater than 1) make up 1 super frame, the number of control channels is 4×K. In other words, control channels of the kth (k is an integer not less than 1 and not more than K) frame in a super frame becomes CCH(k1), CCH(k2), CCH(k3), CCH(k4), where k1=(k−1)×4+1, k2=(k−1)×4+2, k3=(k−1)×4+3, k4=k×4.

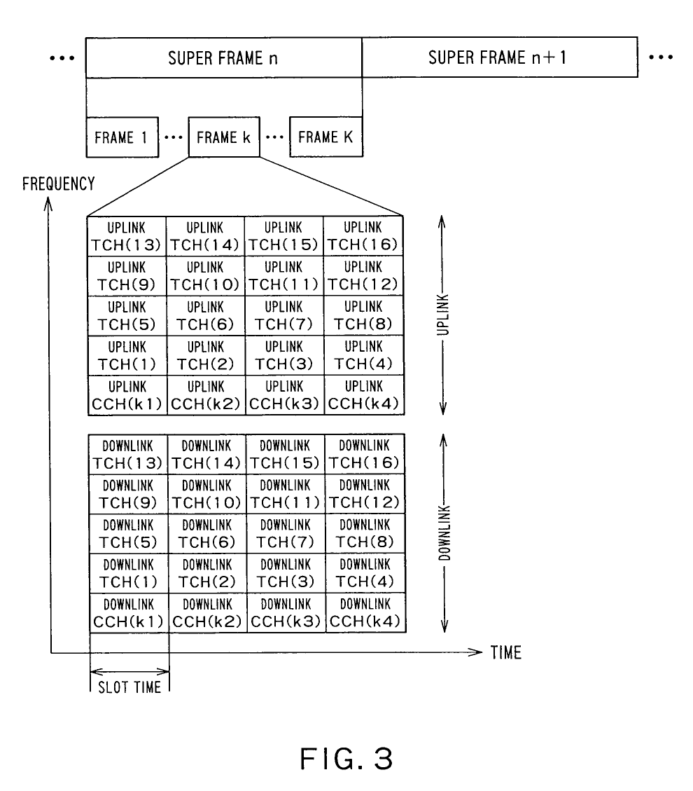

In this embodiment, the number of these channels has no special meaning and if the number of downlink channels and the number of uplink channels are the same, any frame configuration different from that in FIG. 2 has no problem, and as a duplex scheme, the same discussion applies not only to a TDD scheme but also to an FDD scheme as shown in FIG. 3. Furthermore, the modes of the control channel CCH and communication channel TCH do not particularly matter if they at least include a plurality of data symbols. Furthermore, the sizes of the control channel CCH and communication channel TCH, and the radio access schemes of downlink channel and uplink channel need not be the same, but to make points of discussion clear, suppose the sizes of the control channel CCH and communication channel TCH are all the same and the radio access schemes of the downlink channel and uplink channel are both an OFDM scheme in the following explanations.

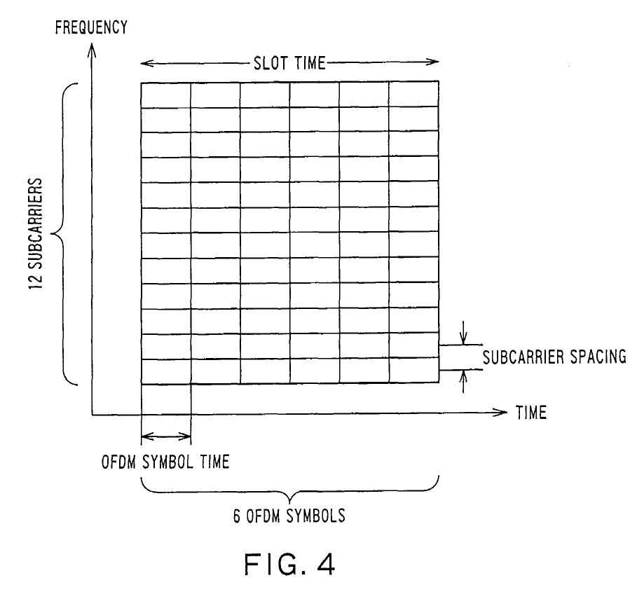

FIG. 4 shows a channel configuration (that is, a slot configuration) according to this embodiment. As shown in the same figure, a channel (control channel CCH, communication channel TCH) is composed of a plurality of OFDM symbols which transmit data symbols with a plurality of orthogonal subcarriers. In the example of the same figure, one channel consists of 12 subcarriers and 6 OFDM symbols and is composed of 96 data symbols.

Differences between the control channel CCH and communication channel TCH in the distributed autonomous radio communication system 10 according to this embodiment will be explained. As for the control channel CCH, each base station BSA to BSE continuously uses certain control channels CCH regularly and uses them to transmit broadcast information and paging information or exchange information for a connection procedure to allocate communication channels TCH to a mobile station MS or the like. On the other hand, as for the communication channel TCH, when each base station BSA to BSE needs a resource for a communication with the mobile station MS, it senses an interference level of the communication channel TCH and uses the communication channel TCH judged to have no problem when it is used. In other words, the communication channel TCH is a channel which is secured temporarily by the base station BS and released when the use thereof is finished. These have basically the same roles as those of a control slot and a communication slot in PHS.

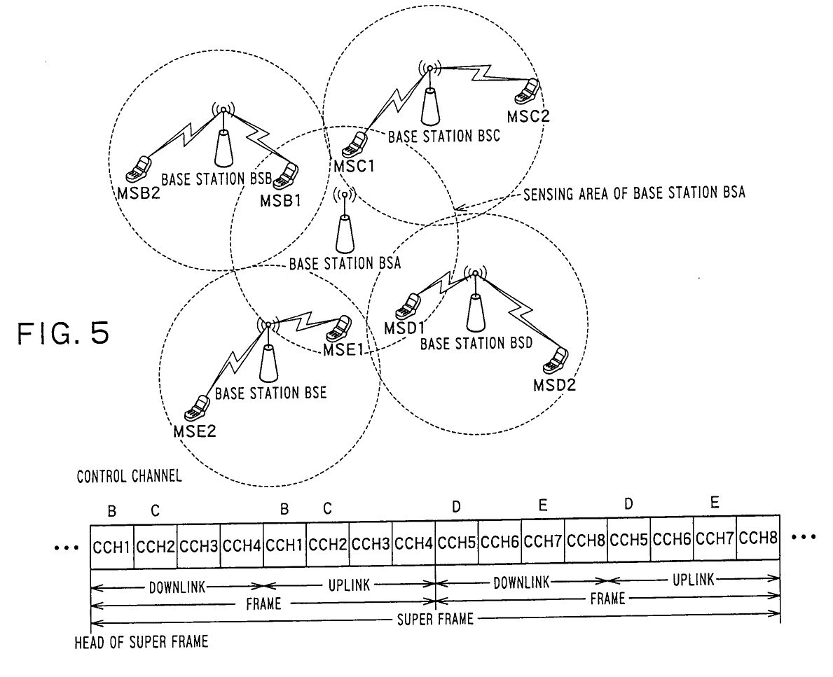

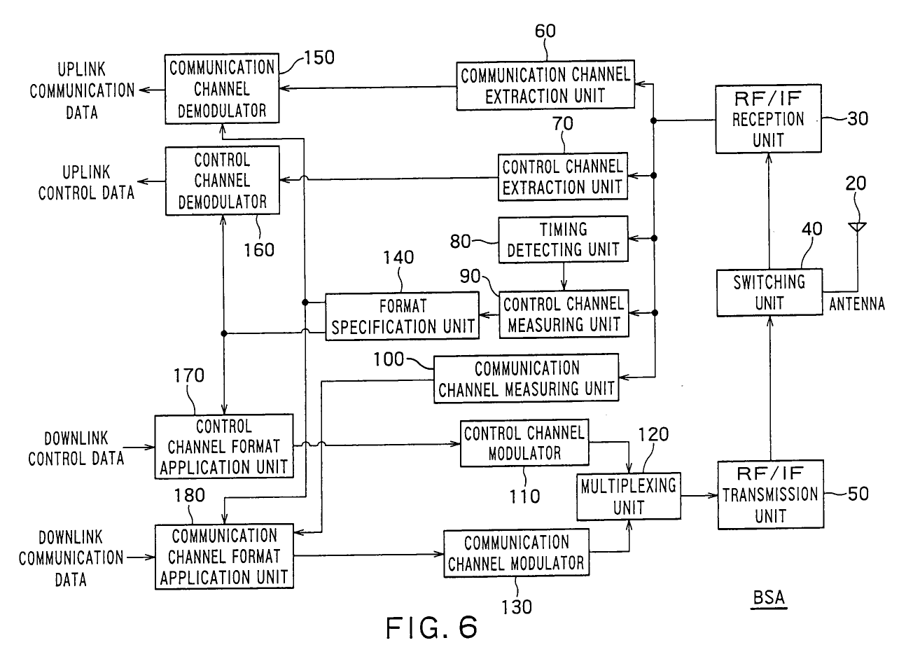

FIG. 5 illustrates the method of determining a control channel CCH used by a base station BS. Furthermore, FIG. 6 shows a configuration example of the base station BSA according to this embodiment. In the example of FIG. 5, eight control channels CCH (CCH1, CCH2, . . . , CCH8) exist in a super frame and each base station BSA to BSE uses only one control channel CCH in the super frame. Each base station BSA to BSE can also use a plurality of control channels CCH defined beforehand as one set, but since similar discussion holds for this, this embodiment assumes that each base station BSA to BSE uses only one control channel CCH in the explanations.

The operation of the base station BSA after starting to operate (power is turned ON) until it starts to use the control channel CCH in a situation in which the base station BSB, base station BSC, base station BSD and base station BSE are operating using CCH1, CCH2, CCH5 and CCH7 respectively will be explained below using FIG. 5 and FIG. 6.

First, in order to accurately judge which control channel CCH is available (idle channel), the base station BSA needs to establish synchronization with the super frame. A timing detecting unit 80 as a synchronization establishing unit of the base station BSA causes the base station BSA to synchronize with the peripheral base stations BSB to BSE with respect to a super frame. The configuration and the operation of the timing detecting unit 80 will be described later.

The base station BSA which has established super frame synchronization then observes a usage situation of control channels CCH in the periphery and searches for a control channel CCH with small interference and determines the control channel CCH which the base station BSA itself uses.

First, the base station BSA sets a switching unit 40 so as to receive data all the time through the downlink and uplink. In the base station BSA, a control channel measuring unit 90 as a control channel search unit measures reception power levels (interference noise power levels) of the respective control channels CCH (downlink control channel, uplink control channel) from a received signal received through an antenna 20 and passed through an RF/IF reception unit 30.

There is no guarantee that the peripheral base stations BSB to BSE reliably use the uplink control channels in all super frames and the reception situation of the uplink control channels depends on the position of the mobile station MS. Therefore, to correctly grasp a peripheral usage situation, it is necessary to measure reception power of the control channels CCH over an extended period of time to some extent. Furthermore, when observing the control channels CCH over a plurality of super frames, a maximum value rather than an average of a plurality of super frames is a more appropriate value as an index of the reception power level of each control channel CCH.

In the situation of FIG. 5, as a result of power measurement of each control channel CCH, the control channel measuring unit 90 observes reception power of CCH1, CCH2, CCH5 and CCH7 with the magnitude when the user is obviously located nearby and judges reception power of other CCH3, CCH4, CCH6 and CCH8 to be small values on the order of noise levels. Next, the control channel measuring unit 90 decides to use control channel CCH with minimum reception power (suppose, for example, CCH3) at the base station BSA. The control channel measuring unit 90 informs a format specification unit 140 that the control channel CCH decided to be used is CCH3.

The format specification unit 140 as a format specification unit decides formats to be used by the base station BSA for the control channel CCH and communication channel TCH respectively according to the control channels CCH used. The base stations BS in the same system store all formats of control channels CCH and communication channels TCH which correspond to the respective control channels CCH in a memory or the like as common information. As for the mobile station MS, all format information may be stored or partial information on the formats may also be supplied from the base stations BS through the control channels CCH as will be described later.

Examples of formats include pilot signals and pilot formats are decided in such a way as pilot signal 1 when CCH1 is selected and pilot signal 2 when CCH2 is selected and so forth. Detailed operation of the format specification unit 140 will be described later.

In FIG. 6, the operation until the base station BSA which has decided a control channel CCH to be used transmits downlink control data such as broadcast information through a control channel CCH will be explained below. A control channel format application unit 170 arranges the downlink control data such as broadcast information on data symbols (subcarriers) in the control channel CCH according to the format specified by the format specification unit 140. Next, the control channel data to which the specified format has been applied by the control channel format application unit 170 is modulated at a control channel modulator 110. When there are communication channel data to be transmitted simultaneously in the same slot time, a multiplexing unit 120 adds up the modulated control channel data and communication channel data and the data is transmitted from the antenna 20 via an RF/IF transmission unit 50. However, once the control channel CCH to be used is decided, the switching unit 40 operates by switching between reception and transmission according to the uplink and the downlink of a frame. At least the control channel format application unit 170, control channel modulator 110, multiplexing unit 120, RF/IF transmission unit 50, switching unit 40 and antenna 20 constitute a base station communication unit.

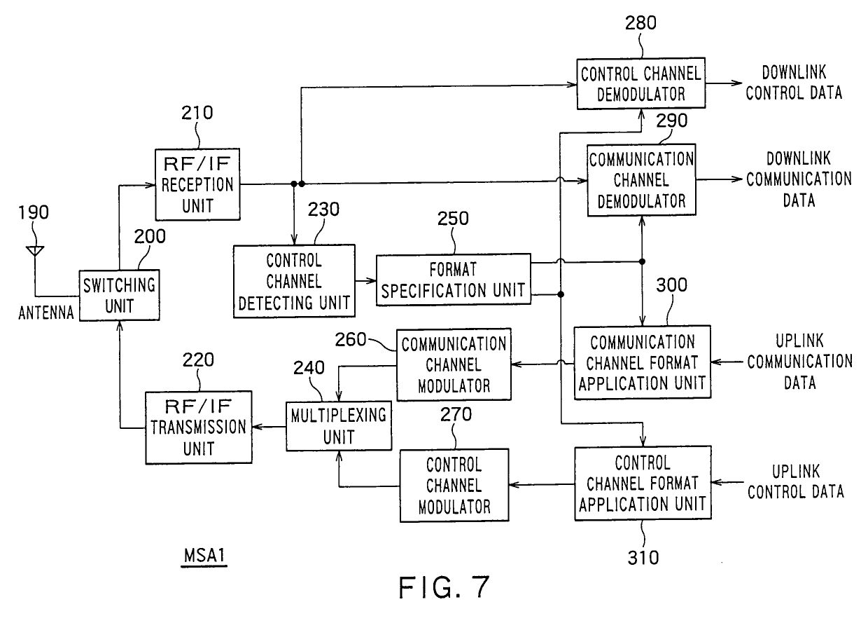

FIG. 7 shows a configuration example of a mobile station MSA1 according to this embodiment. The operation until the mobile station MSA1 demodulates downlink control data transmitted from the base station BSA will be explained below. The mobile station MSA1 detects a control channel CCH transmitted from the base station BSA at a control channel detecting unit 230 as a control channel detecting unit using a received signal received from an antenna 190 and passed through an RF/IF reception unit 210, that is, it performs a base station search. The mobile station MSA1 need not store formats of all control channels CCH and communication channels TCH in advance, but needs to know formats of the downlink control channels in advance to demodulate a downlink control channel first.

When the formats of all downlink control channels include synchronizing signals as common waveforms, the control channel detecting unit 230 can detect a control channel CCH by calculating a correlation between the received signal and the synchronizing signal and, can know the format of the received downlink control channel by demodulating partial data in the control channel CCH and can demodulate the entire control channel CCH through a control channel demodulator 280 by specifying the format of the downlink control channel at a format specification unit 250. At least, the antenna 190, switching unit 200, RF/IF reception unit 210 and control channel demodulator 280 constitute a mobile station communication unit.

Alternatively, when a synchronizing signal peculiar to each downlink control channel is included, the control channel detecting unit 230 calculates a correlation between the received signal and the synchronizing signal peculiar to each control channel CCH, and can thereby detect the control channel CCH and know the number of the control channel CCH simultaneously. This allows the mobile station MSA1 to know the format of the received downlink control channel.

The mobile station MSA1 may store all formats of control channels CCH and communication channels TCH corresponding to the respective control channels CCH as common information in a memory or the like or may know only formats of downlink control channels beforehand and supply format information about other channel formats to the mobile station MSA1 through the downlink control channel.

The operation when the mobile station MSA1 transmits uplink control data to the base station BSA which has transmitted this control data through an uplink control channel to request a communication channel TCH will be explained below using FIGS. 6 and 7. As for the uplink control data, a control channel format application unit 310 forms a data block in a data symbol arrangement according to the uplink control channel format specified by the format specification unit 250 and a control channel modulator 270 applies data modulation thereto. When there is communication data to be transmitted simultaneously, a multiplexing unit 240 multiplexes control data with the communication data. The modulated uplink control data is transmitted from the antenna 190 via an RF/IF transmission unit 220.

The base station BSA receives a signal transmitted from the mobile station MSA1 through the antenna 20, the signal is passed through the RF/IF reception unit 30 and a control channel extraction unit 70 extracts a target channel by adjusting the frequency and time to the uplink control channel. The received data of the extracted received uplink control channel is demodulated by a control channel demodulator 160 according to a predetermined format for the uplink control channel specified by the format specification unit 140 and the uplink control data is demodulated at the base station BSA.

This is the operation related to a communication through the control channel CCH, but the operation through the communication channel TCH is basically the same. As for a communication of communication data between the base station BSA and mobile station MSA1 through the communication channel TCH, it is basically the same as the operation in the case of a communication of control channel data except in that the format specification units 140 and 250 in FIG. 6 and FIG. 7 specify formats to be used on the downlink communication channel and uplink communication channel.

However, as for the communication channel TCH, the base station BSA senses and uses a channel as required. In FIG. 6, the base station BSA measures an interference noise power level of each uplink communication channel at a communication channel measuring unit 100 and searches for such an idle communication channel that the interference noise power level falls to or below a threshold. The base station BSA discovers an idle communication channel and allocates a communication channel TCH through a control channel CCH and after that, the base station BSA and the mobile station MSA1 carry out communication through the communication channel TCH.

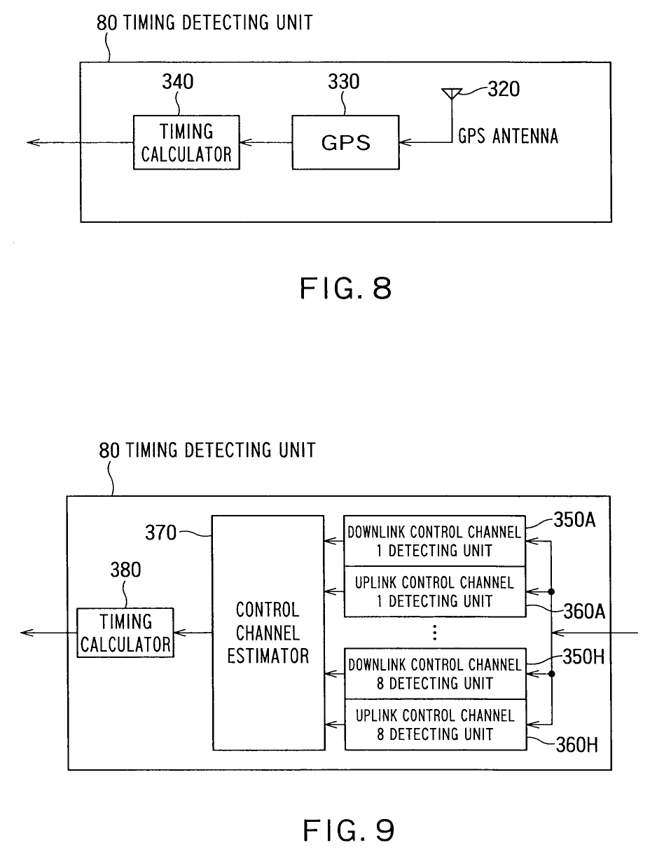

FIG. 8 shows a first configuration example of the timing detecting unit 80 of the base station BSA shown in FIG. 6. In this example, timing at the head of a super frame is detected using a GPS (Global Positioning System) 330. Equipped with the GPS 330, the base station BSA can have a precise clock, and therefore by deciding that the head of a super frame corresponds to, for example, noon 12:00 as a rule of the entire system, a timing calculator 340 can calculate correct super frame timing from the current time.

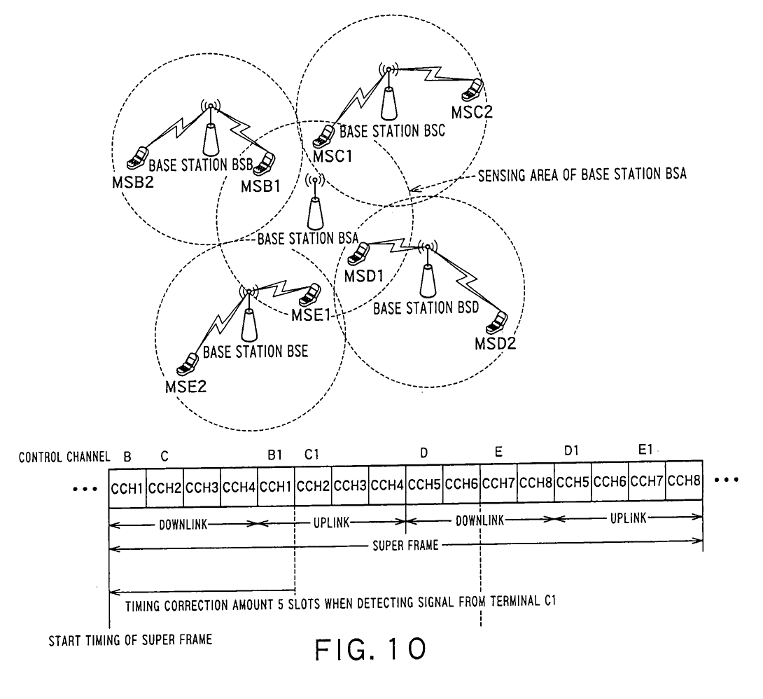

FIG. 9 shows a second configuration example of the timing detecting unit 80 at the base station BSA shown in FIG. 6. To realize this configuration example, as for the format of the control channel CCH specified by the format specification unit 140, the format is specified in such a way that peculiar waveforms are included in the uplink and downlink control channels respectively. The operation of the second configuration example of the timing detecting unit 80 will be explained below using FIG. 10. Downlink/uplink control channel k (k is an integer not less than 1 and not more than 8) detecting units 350A to 350H/360A to 360H calculate a cross correlation between a received signal which has passed through the RF/IF reception unit 30 and a peculiar waveform of a downlink/uplink CCH (k). A control channel estimator 370 informs a timing calculator 380 of a control channel which has outputted a value which is a maximum and which exceeds a threshold out of 16 outputs of the detecting unit, a progressive average over a super frame period of which has been obtained. The timing calculator 380 adjusts timing according to the detected control channel and causes it to synchronize with the super frame. For example, in the case of FIG. 10, when the output of the detecting unit of the uplink control channel 2 (uplink CCH2) is assumed to be a maximum and if the unique waveform of the uplink CCH2 is located at the head of the slot, it is understandable that the start timing of the super frame is a time five slots ahead of the timing at which the uplink CCH2 has been detected.

Alternatively, the control channel estimator 370 may also inform the timing calculator 380 of all control channels CCH which have outputted values exceeding a threshold out of 16 outputs of the detecting unit whose progressive average over a super frame period has been obtained, calculate and average super frame start timing for the respective control channels.

Configuration examples of the formats of control channels CCH and communication channels TCH specified by the format specification unit 140 will be shown below. The basic concept of a format selection according to this embodiment is to provide a plurality of formats for resources (time, frequency, space or the like) in the channel differing in the degree of importance and required quality or differing in the transmission method and reception method respectively, select a format through a control channel CCH determined in a distributed autonomous way, thereby allow the behavior of interference between the base stations BS to be controlled and averaged and realize a distributed autonomous system more robust to interference.

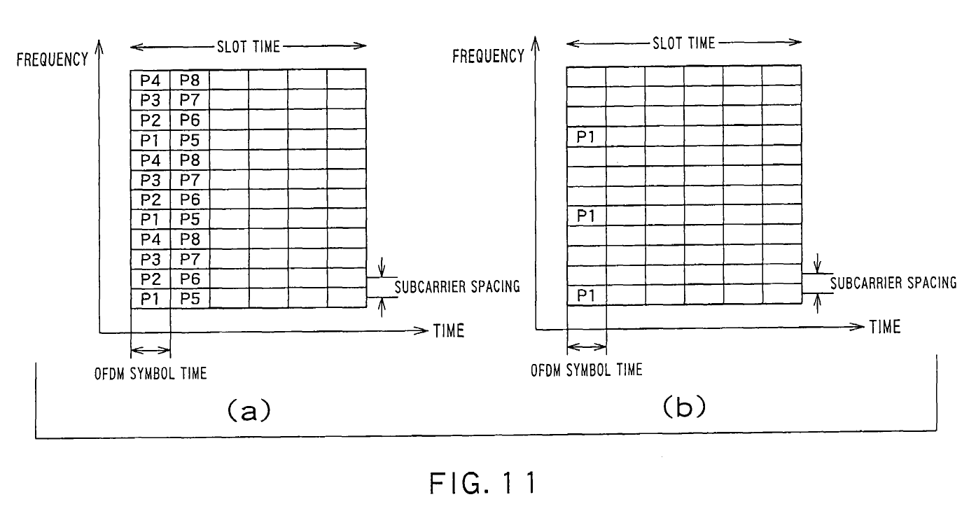

FIG. 11 shows a first configuration example of a channel format specified by the format specification unit 140 according to this embodiment. Eight formats are provided for eight control channels and one format corresponds to one control channel. In FIG. 11(a), eight types P1, P2, . . . , P8 are defined as subcarrier sets for transmitting pilots. As shown in FIG. 11(b), when, for example, the base station BSA uses control channel CCH(1), transmission is performed using subcarriers P1 of the control channel CCH and communication channel TCH as pilots. Furthermore, each base station BS can reduce interference with a different base station BS using the same control channel CCH by multiplying the set of subcarriers used as pilots by a code peculiar to the base station BS.

Generally, high quality pilot signals are necessary to realize high-level signal processing such as a MIMO scheme, beam forming, interference removal or the like. For this reason, it is also important that the base stations BS use pilot signals which are orthogonal to each other. Allocating pilots to the control channels CCH using the above described method allows the peripheral base stations BS to naturally differentiate the use of sets of orthogonal pilots.

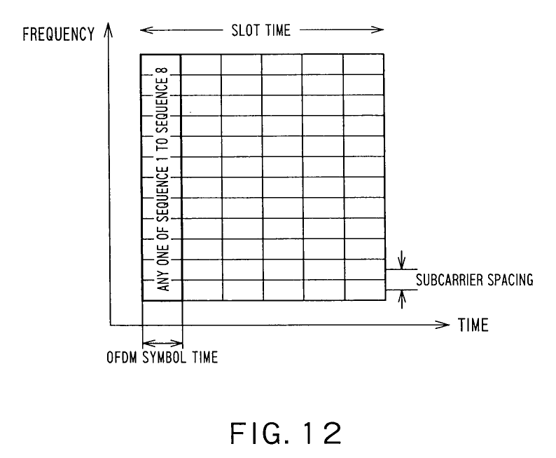

FIG. 12 shows a second configuration example of the channel format specified at the format specification unit 140 according to this embodiment. In the example in the same figure, a sequence which differs from one control channel CCH to another is transmitted with subcarriers of an OFDM symbol at the head. As can also be said in the case of FIG. 11, if different sequences are allocated to the downlink control channel and the uplink control channel, the timing detecting unit 80 shown in FIG. 9 can be realized. The difference between FIG. 11 and FIG. 12 can also be said to lie in that FIG. 11 shows a part peculiar to the format of the control channel CCH subjected to FDM (frequency division multiplexing)/TDM (time division multiplexing), whereas FIG. 12 shows that subjected to CDM (code division multiplexing).

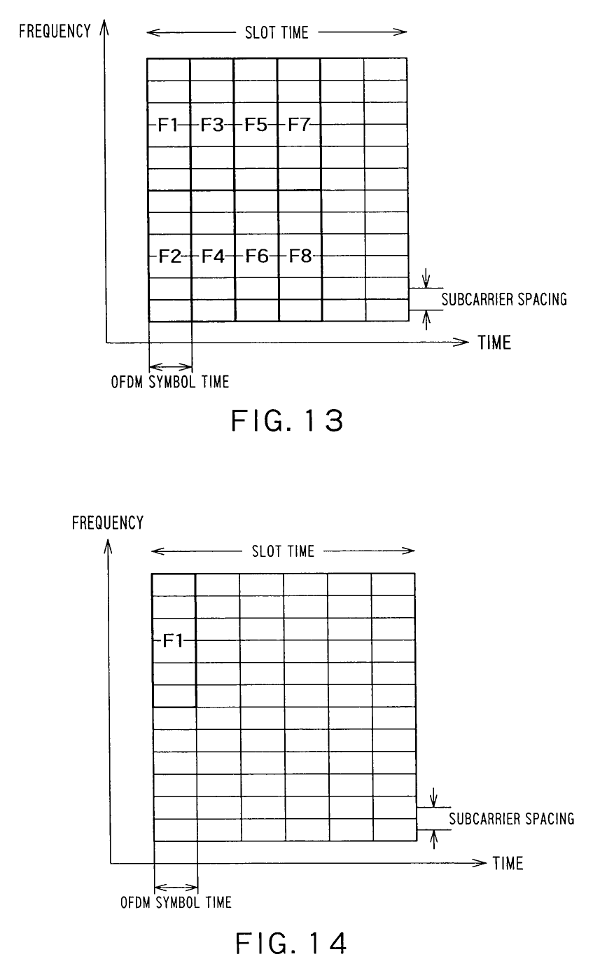

FIG. 13 shows a third configuration example of the channel format specified at the format specification unit 140 according to this embodiment. In the example in the same figure, channels (control channel CCH, communication channel TCH) are divided into two resource areas, which are used differently. When, for example, control channel CCH(1) is used, the channel is divided into a subcarrier F1 and other subcarriers as shown in FIG. 14. As an example of being applied to a downlink channel, as for resources of F1, data directed to a plurality of mobile stations MS is transmitted without performing beam forming and other resources are subjected to beam forming and the data is transmitted to each mobile station MS. As an example of being applied to an uplink channel, as for resources of F1, the mobile stations MS transmit contention based data by random access and for other areas, the right to data transmission is given to a specific mobile station MS according to the allocation by the base station BS.

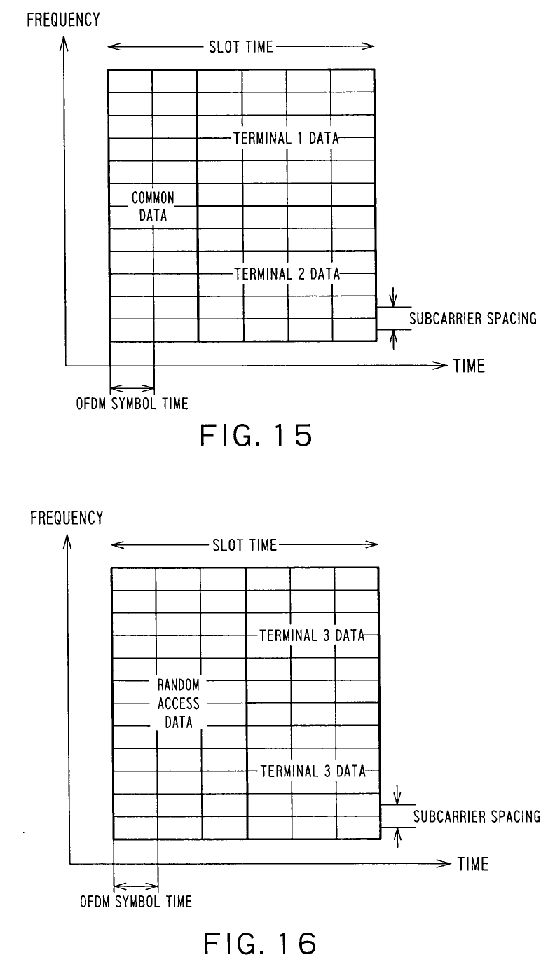

FIG. 15 and FIG. 16 show specific examples of the downlink and the uplink which correspond to the third configuration example of the channel format in FIG. 13. In the downlink channel configuration in FIG. 15, part of the resource area of the channel is used as common data such as scheduling information, transmitted without performing beam forming, and the rest of the area is individual data for the mobile station 1 and mobile station 2 and transmitted after being subjected to beam forming directed to the respective mobile stations. In this case, the position of the resource in the common data part varies depending on the control channel CCH used by the base station BS. In the configuration example of the uplink channel in FIG. 16, part of the resource area of the channel is a resource for random access used by a plurality of mobile stations on a contention basis and the rest of the resource area is used for data transmission dedicated to the mobile station 3 and mobile station 4. In this case, the position of the resource in the random access data part varies depending on the control channel CCH used.

In the third configuration example, by changing the arrangement in the channel of a resource for which beam forming is performed and a resource for which beam forming is not performed, it is possible to avoid interference in the channel from concentrating on a specific resource and further average the behavior of interference.

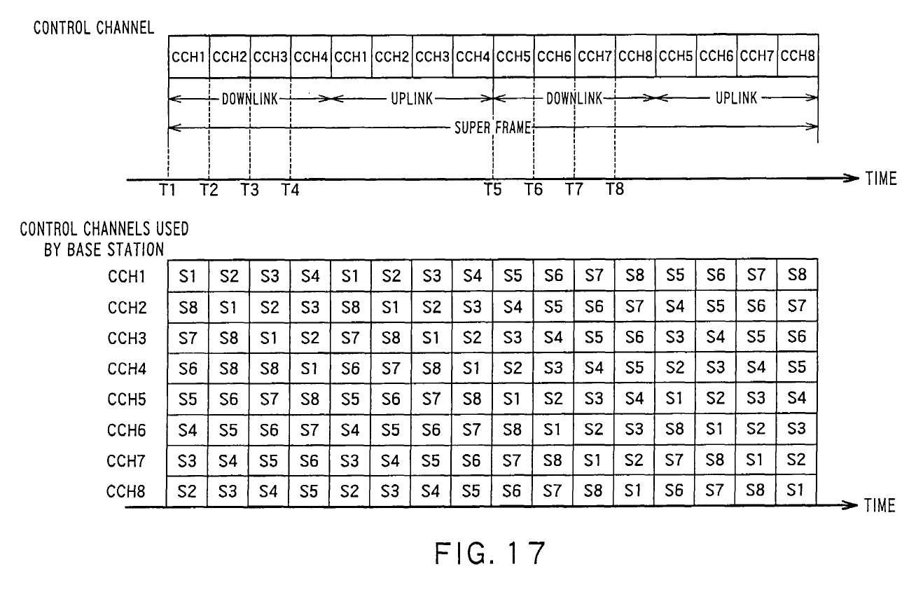

FIG. 17 shows a fourth configuration example of the channel format specified by the format specification unit 140 according to this embodiment. In the fourth configuration example, a plurality of sets of channel formats (eight types of format from S1 to S8 in FIG. 17) are defined for the respective control channels CCH and the base station BS specifies a format to be used from among S1 to S8 depending on the time slot position in the super frame according to the control channel CCH to be used. Periodically changing the format to be used in this way allows the base station to change the behavior of interference in the channel while keeping a certain balance with the channel formats used at peripheral base stations. The operations of the format specification unit 140 in the first to third configuration examples shown in FIG. 11 to FIG. 16 are to change the configuration inside the channels (control channel CCH, communication channel TCH) according to the control channel CCH used by the base station BS. On the other hand, the operation in the fourth configuration example of the format specification unit 140 shown in FIG. 17 is a method of specifying the format of a communication channel TCH according to the slot positions in a super frame of the control channel CCH and communication channel TCH used by the base station BS.

The above described channel format configuration examples have explained the case where the number of control channels and the number of formats are all the same, but the case where the number of control channels and the number of formats are different can also be easily thought of by extension.

For example, when the number of formats exceeds the number of control channels, a plurality of formats may be allocated to one control channel CCH and the base station BS may select a format from among those formats according to a certain rule (random, round robin, decision based on a slot number or the like). When the number of formats is smaller than the number of control channels, instead of using such a set of formats as they are, it is preferable to use the format set after newly adding a format multiplied by, for example, a random bit sequence to the format set and thereby increasing the number of formats so as to exceed the number of control channels.

As described above, this embodiment changes the formats used for control channels CCH and communication channels TCH according to the positions in a super frame of the control channels CCH used by the base station BSA, and can thereby allow the distributed autonomous radio system 10 which does not elaborately calculate the arrangement of base stations BS to autonomously divide pilot signals and specific resources among the peripheral base stations BSA to BSE and use them, averagely control the amount of interference from other base stations BSB to BSE and reduce influences of interference from the other base stations BSB to BSE.

What is claimed is:

1. A radio communication system using frames each including a plurality of control channels and a plurality of communication channels as transmission units, comprising at least a base station and a mobile station communicating therebetween by radio,
the base station comprising:
a synchronization establishing unit configured to detect start timing of a super frame formed of a plurality of frames and establish synchronization of the super frame with other base stations;
a control channel searching unit configured to measure reception power levels of the control channels, search for the control channel having a small reception power level and thereby determine the control channel to be used;
a format specification unit configured to specify a desired channel format from among a plurality of channel formats according to a determined control channel to be used; and
a base station communication unit configured to communicate with the mobile station using the desired channel format, and
the mobile station comprising:
a control channel detecting unit configured to detect signals of the control channel transmitted from the base station; and
a mobile station communication unit configured to communicate with the base station using the channel format specified at the base station.

2. The system according to claim 1, wherein the channel formats are provided in such a way that signals in a fixed pattern that form the control channels and the communication channels are orthogonal to each other among the channel formats.

3. The system according to claim 1, wherein the channel formats are provided in such a way that resource positions to which a plurality of types of signals that form the control channels and the communication channels are allocated differ from each other.

4. The system according to claim 3, wherein the plurality of types of signals include
signals commonly transmitted to the mobile stations without being subjected to beam forming and
signals subjected to beam forming and then individually transmitted to the mobile stations.

5. The system according to claim 3, wherein the plurality of types of signals include
signals transmitted from the mobile stations through random access and
signals transmitted from the mobile stations given transmission permission from the base station.

6. The system according to claim 1, wherein the channel formats are provided in such a way that the configurations of the control channels and the communication channels vary from one frame to another with the super frame as a period and the configurations of the control channels and the communication channels have different variation patterns.

7. The system according to claim 1, wherein the synchronization establishing unit comprises:
a correlation calculator configured to calculate correlations between received signals and a plurality of signals made up of unique signal waveforms that the control channels have respectively;
a control channel estimator configured to compare a plurality of correlation values obtained by the correlation calculator with a predetermined threshold and estimate the control channel whose correlation value is equal to or higher than the threshold and is a maximum; and
a timing calculator configured to calculate start timing of the super frame using an estimated control channel.

8. A base station using frames each including a plurality of control channels and a plurality of communication channels as transmission units, communicating with a mobile station by radio, comprising:
a synchronization establishing unit configured to detect start timing of a super frame formed of a plurality of frames and establish synchronization of the super frame with other base stations;
a control channel searching unit configured to measure reception power levels of the control channels, search for the control channel having the small reception power level and thereby determine the control channel to be used;
a format specification unit configured to specify a desired channel format from among a plurality of channel formats according to a determined control channel to be used; and
a base station communication unit configured to communicate with the mobile station using the desired channel format.

9. A radio communication method for a radio communication system using frames each including a plurality of control channels and a plurality of communication channels as transmission units, comprising at least a base station and a mobile station communicating therebetween by radio, comprising:
detecting by the base station start timing of a super frame formed of a plurality of frames and establishes synchronization of the super frame with other base stations,
measuring by the base station reception power levels of the control channels, searching for the control channel having the small reception power level and thereby determining the control channel to be used,
specifying by the base station a desired channel format from among a plurality of channel formats according to a determined control channel to be used, and
communicating with the mobile station using the desired channel format, and
detecting by the mobile station signals of the control channel transmitted from the base station, and
communicating with the base station using the channel format specified at the base station.
